(19) United States
(12) Patent Application Publication
(10) Pub. No.: US 2005/0007223 A1
(43) Pub. Date: Jan. 13, 2005

(54) Magnetic switching system

(76) Inventor: Herbert C. Schulze, Reno, NV (US)

Correspondence Address: Herbert C. Schulze, PMB36, 2790 Wrondel Way, Reno, NV, 89509, US

(21) Appl. No.: 10/615,473

(22) Filed: Jul. 7, 2003

(51) Int. Cl. H01H 9/00

(52) U.S. Cl. 335/205

(57) ABSTRACT

This is an electrical switching method and apparatus wherein a magnetic reed switch is activated by means of a disc magnet moving into and out of the magnetic field of the magnetic reed switch. The motion of the disc magnet is caused by gravity, a change in the orientation of a device supporting the disc magnet, a flow of fluid against the disc magnet, an impact affecting the disc magnet, vibration, fluid level changes, or other forces causing the disc magnet to roll or otherwise change its position with respect to the magnetic reed switch. Variations include means by which paraplegics and other invalids can signal for assistance or communicate by blowing breath against disc magnets and where a bank of disc magnet devices can control a diversity of devices such as bed controls, televisions, telephones, etc.

### CROSS REFERENCE TO RELATED PATENT APPLICATIONS

This application is related to my co-pending application on Emergency and Disabled Persons Communication Business Model Algorithm and Method and Apparatus Ser. No. 10/351,092, filed Jan. 22, 2003, now Ser. No. ______.

### BACKGROUND OF THE INVENTION

I. Field of the Invention

This invention is in the general fields of magnetic electrical switching and motion and environment detection and monitoring;

The invention is more particularly in the fields of sensitive, silent, reliable, easily activated, and consistently repeatable switching for use in magnetic activation of alarms, monitoring systems, switching systems, environmental condition reporting, and the like.

The invention is most particularly in the field of novel, unique and useful applications of rolling disc magnets and magnetic reed switches and wireless signal transmission for economical, accurate, dependable, sensitive, and silent electrical switching, monitoring, signaling, and communication.

The invention is also in the field of switching and the like systems suitable for use in communication and the like by persons who are disabled, ill, elderly, handicapped and the like.

The invention is also in the field of detection of, response to, and recording of, motion, changes of environment and other attributes of objects and systems.

II. Description of the Prior Art

There are many emergency alarm and monitoring systems, communication systems, and electrical switching systems. There are many switching systems using magnets and magnetic reed switches and the like.

Impact switches, vibration switches, and the like are widely used. Many such systems require considerable motion or force for activation. There are motion and impact switches which use spring loaded magnets and the like to detect or react to conditions of impact or the like. There are also switches which activate using a bar magnet to act upon a magnetic reed switch.

Also, there are existing nurse call systems in which a quadriplegic or the like can blow through a tube in such manner as to activate a pressure transducer or press upon a pressure sensitive item, or twitch an eyebrow or the like to activate complex and expensive pressure sensitive devices for activation.

In all of the devices and methods I have studied I have found nothing to suggest nor anticipate my newly developed unique, novel, and useful sensitive rolling magnetic disc switches which activate magnetic reed switches by rolling magnetic discs into or out of the magnetic field of influence of the magnetic reed switchs. In particular, my invention as detailed below allows paraplegics and other disabled persons to communicate or activate devices by merely blowing lightly against, or slightly touching or tilting, a sensitive magnetic disc or device containing a magnetic disc. The disc rolls or moves a minute distance into and/or out of the magnetic field of influence of a magnetic reed switch thus activating a device such as a radio frequency transmitter, an alarm light, a television set, a medical device or the like.

Additionally, I have found that I can control and restrain magnetic discs by other magnets or the like so that the magnetic discs will only release and activate or deactivate reed switches or the like upon the happening of an event such as an impact or the like of a predetermined magnitude, a change in environment or motion, or the like. In this respect I have been able to accomplish electrical switching by impact, vibration, tilt, level, temperature variants, and the like. Switches according to the teachings of this invention can be set at an infinite and very precise activation level to react, respond to, record, and the like the magnitude, quantity, or nature of force, irregularity, tilt, impact, vibration, and the like of events. I can even activate my unique, novel and useful magnetic disc/magnetic reed switches by such diverse means as sensing temperature changes and by using thermocouples or the like as will be understood by those skilled in the art, by eyebrow, scalp, muscle, and the like movement.

I embarked on this search because of a personal tragedy in which my wife suffered a severe stroke which left her nearly completely paralyzed and with great problems of coordination and communication. I searched for answers to my wife's, and my own, frustration over this discomfort for my wife and the inability to communicate.

I have searched literature, patent data bases, and commercially available products. I have consulted with persons engaged in medical equipment businesses, emergency telephone businesses, motion detecting, switching businesses, and a variety of other businesses. I have been unable to find anything which reveals, anticipates, nor suggests the unique, novel, and useful algorithms, methods and means I finally personally conceived and developed, and which are disclosed, discussed, and claimed below. Thus, I believe there is no properly applicable prior art disclosing, anticipating, or suggesting the novel, unique, and useful items as hereinafter taught and claimed.

### BRIEF SUMMARY OF THE INVENTION

There are many uses for silent, hands free activation of communication, monitoring, data recording, environmental, event anticipation, and the like devices. There are many so-called “hands free” and “ADA Compliant” devices such as telephones, monitoring systems, disabled persons calling systems, and the like. Frequently such items are not truly “hands free” or suitable for use by severely handicapped or disabled persons in that many items require more physical ability and coordination than such persons possess.

Until my afore mentioned related patent application, systems for satisfying certain needs of such persons as paraplegics and other severely handicapped, or injured, and the like required reasonable physical and mental ability and coordination for communication and activation of devices such as hospital beds, televisions and radios, nurse call systems, and the like were largely non-existent. For example, there are many wireless monitoring systems with pendants which can be which can be activated by pushing a button or the like. While such devices are very valuable there are many situations in which they are of no value. In the case of wife's condition (mentioned above) these monitor devices with their push button pendants were of no value since my wife did not have proper finger coordination and strength to activate the pendants. While the inventions of my afore mentioned patent application has solved a great many of the problems facing elderly, ill, and disabled persons, I continued my research into the problems of such persons and related areas of interest. My afore-mentioned related patent application also addressed a need for undetectable, silent activation of alarms and the like for home security purposes and the like.

Additionally I found that there is a great requirement for improved sensitive environmental and motion detection devices to detect changes such as movement of structures due to earth movement or the like, fluid level detection, vibration control, impact detection, and the like.

In my research I have been studying the needs of spinal injury victims and the like. There are some nurse call systems which employ tubes inserted in the mouths of paraplegics and the like in order for such persons to be able to blow through the tube to activate pressure transducers to signal that attention is needed. Also, there are some expensive high tech pressure touch pads to activate alarms or the like. Such devices are costly and may require costly maintenance. My present invention includes a novel, unique, useful, and more economic and versatile system for paraplegics and the like to communicate and operate devices.

I have developed what I refer to as “rolling magnetic disc switch activation”. I cause magnetic reed switches to be activated or deactivated by rolling magnetic discs or balls containing magnets or the like into or out of the magnetic fields of magnetic reed switches or the like in order to activate or deactivate the magnetic reed switches. Throughout this document, wherever I use the term “magnetic field” I mean that space wherein a magnet will activate a magnetic reed switch.

As well as being valuable for use by disabled persons and the like, my rolling magnetic disc switch activation systems are superior switching systems for use in detecting minute events or changes in attitudes of objects and the like as well as dramatic occurrences. These switches have use in a wide variety of situations where detection of delicate or dramatic change, or notification of a need, or activation of equipment and the like is desired.

It is an object of this invention to provide algorithms or methods for activating electrical devices and the like;

Another object of this invention is to provide methods and means for incapacitated, injured, ill, handicapped, and the like persons to communicate, activate devices, and the like;

Another object of this invention is to provide notification system which will not be recognized as being activated by, nor be annoying to persons in the area where the notification is being given;

Another object of this invention is to provide a monitoring system which can give notice of an emergency or the like without requiring precise physical or vocal ability;

Another object of this invention is to provide an impact or other motion sensing method and means;

Another object of this invention is to provide a method and means for silent and remote activation of devices;

Another object of this invention is to provide an inexpensive and superior monitoring and communication system.

The foregoing and other objects and advantages of this invention will become clear to those skilled in the art upon reading the description of a preferred embodiment, which follows, in conjunction with a review of the appended drawings.

### BRIEF DESCRIPTION OF THE SEVERAL VIEWS OF THE DRAWINGS

FIG. 1 is a schematic perspective of a device, with parts exploded, suitable to practice the algorithm and methods of this invention;

FIG. 2 is an exploded view of all of the elements of FIG. 1;

FIG. 3 is a schematic perspective of an alternative activating item;

FIG. 4 is a section on 4-4 on FIG. 3;

FIG. 5 is a schematic, partially broken away, perspective of an alternate embodiment of a device to practice some of the algorithms and methods of this invention; and

FIG. 6 is a schematic perspective of an alternate embodiment of a device to practice some of the algorithms and methods of this invention.

### DESCRIPTION OF A PREFERRED EMBODIMENT

An inventory of items bearing reference numerals on the drawings is:

Numeral Item

10 transmitter box generally
11 front of transmitter box
12 right side of transmitter box
13 back of transmitter box
14 left side of transmitter box
15 opening for push button
16 transmitter box mounting stud
20 transmitter generally
21 front of transmitter
22 right side of transmitter
23 rear of transmitter (not visible)
24 left side of transmitter (not visible)
25 top of transmitter
25a connectors for reed switch leads
26 bottom of transmitter
28 opening for mounting stud
29 push button
30 magnetic disc/reed switch assembly generally
31 bottom of disc/switch track
31a opening in track bottom for insertion of reed switch leads
32 left side of disc/switch track
32a opening in left side of track
33 center partition
34 right side of disc/switch track
35 back of track
36 front of track
36a opening in front of track
37 magnetic disc
38 magnetic reed switch
38a reed switch leads
39 track top cover
39a opening in top cover
40 ball
41 ball material
42 magnet
50 alternate magnetic disc/reed switch alarm device
51 bottom of track
52 right side of track
53 left side of track
54 magnetic disc
55 magnetic reed switch
56 alarm
56a switch contact
56b switch contact
56c alarm mounting
57 electrical lead
58 electrical lead
59 electrical lead
60 battery
61 battery pole
62 battery pole
70 alternate magnetic disc switch device
71 side rail
72 end
73 side rail
74 center rail
75 bottom
76 front partial barrier
77 magnetic reed switch
78 electrical lead
79 electrical lead
80 disc magnet
81 electro magnet
82 electrical lead
83 electrical lead
84 disc magnet track
85 reed magnet track

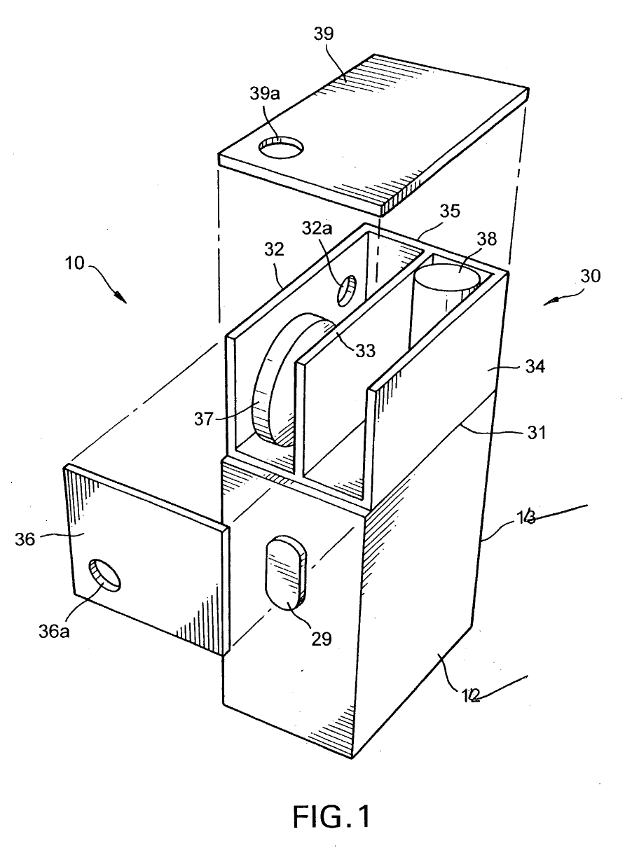

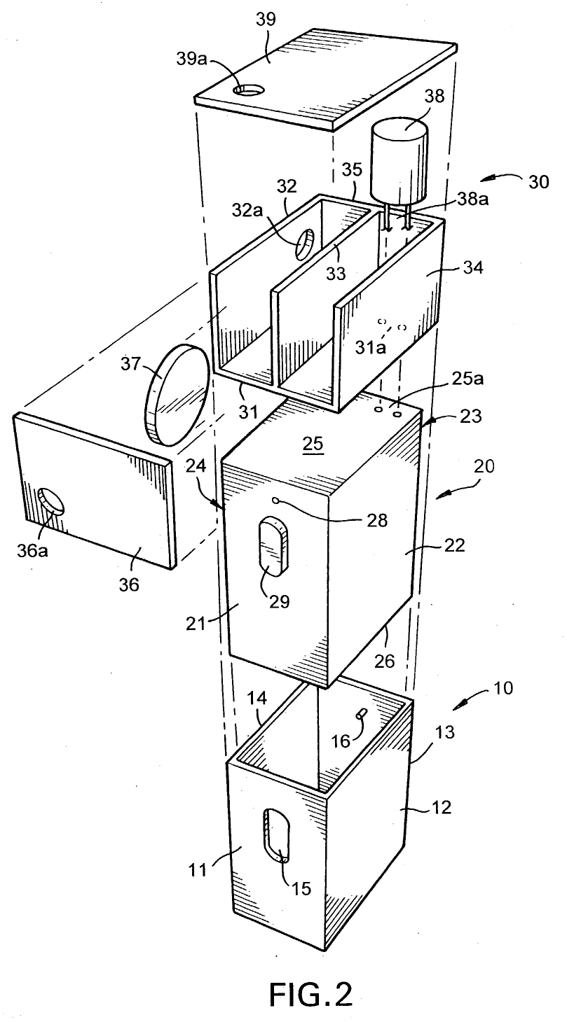

FIGS. 1 and 2 are best viewed together. In this embodiment, a radio frequency transmitter or the like 20 having front 21 with push button activator 29, right side 22, rear 23, left side 24, top 25 with connectors 25a for reed switch leads, bottom 26, and left side 14 is located within a suitable transmitter box 10 which has front 11 with an opening 15 for the push button activator 29, right side 12, back 13, left side 14, and transmitter mounting stud 16.

Magnetic disc/reed switch assembly generally 30 is connected to the top of the transmitter box. It consists of bottom 31 with openings 31a for magnetic reed switch leads, left side 32 having an opening 32a, center partition 33, right side 34, back 35, front 36 having an opening 36a, magnetic disc 37, magnetic reed switch 38, top cover 39 with an opening 39a.

In operation, the magnetic disc 37 is initially adjacent the front wall 36 which is shown exploded away in FIG. 1 but it will be understood by those skilled in the art that in use it will be fastened in place at the front of the track by adhesives or other appropriate fastening means The disc will be adjacent the opening 36a which is smaller than the disc so that the disc cannot drop out of the track. The track will be slightly inclined downwardly at the front so that the disc magnet will tend to remain adjacent the front and out of the magnetic field of the magnetic reed switch. The magnetic reed switch will be normally open.

Tilting the entire apparatus so that the back end of the track bottom 31 is lower than the front end will result in gravity causing the disc magnet to roll toward the back of the track and into the magnetic field of the magnetic reed switch which will cause the switch to activate. The transmitter will be activated by the activation of the magnetic reed switch as the transmitter's leads 57 are connected across the terminals of the push button transmitter switch 28, as will be understood by those skilled in the art.

A great advantage of this device is that when the device is mounted so that the front of the track bottom is slightly lower than the back end of the track bottom gravity will hold the disc magnet adjacent the front and adjacent opening 36a and beneath opening 39a in the top. A very slight movement of air through opening 36a or 39a will move the disc magnet. A very slight puff of breath from a paraplegic or other disabled or infirm person will cause the disc to roll into the magnetic field of the reed switch. I have made such units where the amount of movement of the disc required for activation can be one millimeter or less. For this purpose I have found that a disc magnet three eighths of an inch in diameter, one quarter of an inch thick, and weighing about a sixteenth of an ounce obtainable from Edmund Scientifics in Tonawanda, N.Y. and a magnetic reed switch such as Caltronic magnetic switch number 35-17W obtainable from Sandy's Electronic Parts in Reno, Nev. make an excellent embodiment for some of the inventions disclosed in this application, and in particular for the breath activation described.

While I have identified a particular disc magnet and magnetic reed switch, this is not meant to be a limitation. In some applications of this invention it may be that very large and heavy, or even smaller and lighter disc magnets are more desireable. For example, in some heavy industries there is constant vibration and other movement. In such industries, however, it is necessary to detect and correct an abnormal vibration or the like. Thus the disc magnet/magnetic reed switch may require large and heavy disc magnets, restraining devices, and abnormally protected magnetic reed switches and the like. Therefore, it is to be understood that there is no limitation intended as to any examples I may have used or will use in this document.

The magnetic disc/magnetic reed switch assembly can be mounted to a bed rail or any other object by an axle and bearing or the like (not shown, but understood by those skilled in the art) in such a manner that only the slightest touch can activate it, or it can be mounted so that a more substantial force is required for activation. This will be understood by those skilled in the art.

In this way a most severely disabled person is able to call for help, turn on a television, and activate just about any device. It is not necessary to use a tube or straw to blow upon the disc to cause its movement, as is necessary with presently know systems using pressure transducers. However, in a variation, a tube or straw can be inserted into opening 36a or 39a if the particular user desires to operate that way.

Opening 32a is not necessary but has been provided to insure that air will circulate freely.

The wireless (Radio Frequency) units I have used have been the transmitting and receiving circuits from Trine wireless door chime units available from Desa International of Bowling Green, Ky. and GE Wireless Door Chimes available from GE Home Electric Products, Inc. of Nela Park, Cleveland, Ohio. I have merely connected the switch terminals of the transmitter unit to the magnetic reed switch leads for the wireless units I have made. I have disconnected the speaker leads from the receiving/chime unit and connected those leads to the coil of a relay and connected the relay leads to an alarm, telephone activator, or other device. When the receiving unit receives the signal transmitted by the transmitter, the current which would have gone to the speaker (the chime) of these units now activates the nurse call, alarm, or other device.

Those skilled in the art will also understand that the transmitter could utilize the magnetic reed switch directly for activating the transmitter without having a push button switch. However, it is deemed preferable to have the push button switch as well in the event a nurse or other person prefers to have that option.

If it is desired to maintain a prolonged connection across the switch this can be done with latching relays or the like as will be understood by those skilled in the art.

It may appear from the illustrations that it might take a more vigorous blowing than some invalids and the like could muster. This is not true, however. I am able to set the position of the disc such that a movement of a fraction of a millimeter is all that is required to close the reed switch. An extremely slight blowing, or exhaling into the opening will cause that minor amount of movement of the disc magnet.

Alternate means for moving the disc into activation of the reed switch including jolting the device and tilting it.

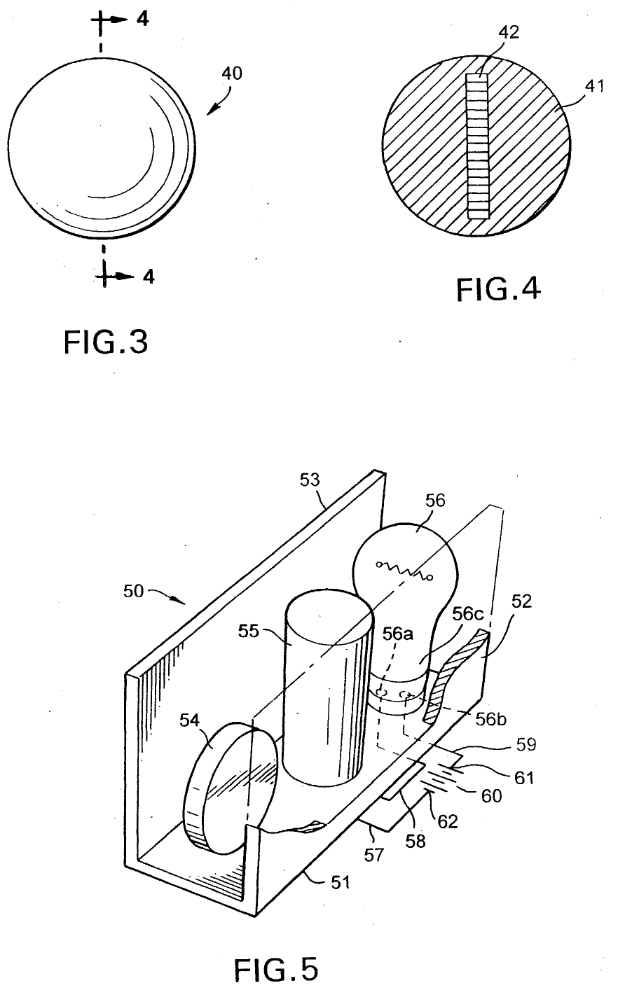

It has occurred to me that some persons might prefer to roll a magnetic ball in place of a disc. However, a normal ball of magnetic material cannot be magnetized since a perfect ball cannot provide a place for north and south poles which must be present in order to have a magnet. Therefore I have made a ball which exhibits magnetic properties by embedding a bar magnet or the like in a ball of other material. Such a device is shown in FIGS. 3 and 4. A ball 40 of virtually any material contains a bar magnet or the like. This is generally not desireable, however, as different portions of the exterior of the ball exhibit differing magnetic qualities. I have found the use of disc magnets to be most desireable and reliable.

FIG. 5 illustrates an extremely simplified version of my invention where a simple alarm or notification light or the like 56 can be activated by the rolling motion of a disc magnet. A track 50 is formed of a track bottom 51 and two track sides 52 and 53. An alarm or notification lamp 56 or the like is mounted in or adjacent the track. A normally open magnetic reed switch 55 is mounted in or adjacent the track. Lead 57 from the reed switch is connected to one pole 62 of a battery or the like 60. Lead 58 from the reed switch is connected to one terminal 56a of the lamp or the like 56. A second pole 61 of the battery or the like 60 is connected by lead 59 to a second terminal 56b of the lamp or the like 56. When the disc magnet moves into the magnetic field of the reed switch the switch will close and the lamp 56 or the like will be activated. As in all of the uses of the switches of this invention, if prolonged contact is required that may be achieved by using latching relays or the like as will be known to those skilled in the art.

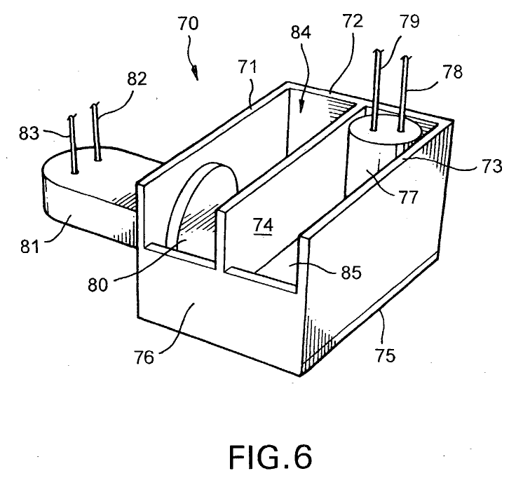

FIG. 6 is a schematic perspective of another alternate of a device to practice the algorithms and methods of this invention. A disc magnet 80 can roll in a track 84 formed by side rail 71, end 72, center rail 74, bottom 75, and front barrier 76. A magnetic reed switch 77 is mounted in track 85 which is formed by side rail 73, end 72, center rail 74, bottom 75, end 72, and front barrier 76. Two electrical leads 78 and 79 are connected to the reed switch 77. A magnet 81 is mounted to the side 70. In this case, two electrical leads 82 and 83 are shown. In this case the magnet 81 may be an electromagnet. The electromagnet when energized, or other disc magnet restraining means, will tend to restrain and hold the disc magnet in the position shown at the front of the track 84. If a sufficient impact is applied toward the back 72 as for example by the device being mounted upon a vehicle and colliding with another object, the disc magnet 80 will break away from the attraction of the magnet 81 and roll to the back and into the magnetic field of the reed switch causing the reed switch to close and complete a circuit between leads 78 and 79. Normally the disc magnet 80 will immediately be pulled back by the magnet 81, however the circuit between leads 78 and 79 may be maintained if desired by means known to those skilled in the art such as latching relays or the like. The disc magnet 80 may also be caused to move by a sufficient angular displacement of the mechanism, by vibration, or the like as will be understood by those skilled in the art. It will be understood that a permanent magnet or a magnetically attractable material such as a block of steel or the like could be used to restrain the disc magnet rather than the electromagnet as shown here. Also, the electromagnet or the like could be located in various other places than as shown in FIG. 6, such as beneath the disc track, or the other side of the track, or any place to accomplish the desired effect.

Other disc magnet restraining means could include springs, adhesives, fracture-able restraints, and the like. Preferably the restraints will be such that they will cause the disc magnet to return to its original position after each impact or the like has dislodged it.

Also, in all of the applications and deviations of this invention the reed switch may be mounted in the same track as the disc magnet or in various other configurations as will be understood by those skilled in the art. Other variations may occur to those skilled in the art without departing from the concepts, teachings, and inventions which fundamentally include the rolling or movement of the disc magnet with relation to the magnetic field of a reed switch.

I have referred to a normally open magnetic reed switch. It is also possible for this invention to work in exactly the reverse manner. That is, a normally closed magnetic reed switch could be caused to open by moving a disc magnet within the magnetic field of the reed switch. This would be useful where a monitor light or the like was desired to be on for purposes of allowing visual observation that a given system was properly functioning and the light or a sound or the like gave assurance of that. The monitor light or the like would go out when a condition occurred which indicated the disc magnet had rolled out of the magnetic field of the reed switch.

Additional uses for this switch system include tilt indication, fluid level control, seismic activity detection, temperature control, and a variety of environmental indicators as will occur to those skilled in the art.

One particular important new, novel, and useful use of the magnetic disc switching systems is the provision for a plurality of these devices preferably mounted as an easily accessible bank of switches to control several or all actions such as bed raising and lowering, television, radio, telephone, nurse call, and the like. When this is done with wireless disc magnet switching it results in great economies and improved safety and comfort for invalids and the like. In this application of the disc magnet switching systems each of the wireless transmitters will be on a frequency separate from each of the others, and each of the receivers will be on a frequency matching the frequency of one of the transmitters. In this manner patients or others can operate necessary apparatus for their comfort, safety, and pleasure resulting in relief for care-givers, nurses, and the like. Additionally in hospitals, nursing homes and the like the activities of a patient in activating various devices will be less likely to annoy other patients as these activations will be virtually silent.

Another important benefit of the wireless magnetic disk/magnetic reed switch is that it is completely oxygen safe and explosion proof. The switching for nurse calls, and the like will be totally without any exposed contacts of any type. The switching to activate a call is taking place in an hermetically sealed device (the magnetic reed switch). The activation of any device or the like can take place at a distance from the disc magnet/magnetic reed switch thus completely eliminating any danger of explosion or fire at the location of the disc magnet/magnetic reed switch.

In this document I may use the terms “disc magnet” and “magnetic disc”. Both of these terms mean the same thing and that is a circular object having magnetic properties, as will be understood by those skilled in the art.

Also in this document I use the terms “magnetic disc/magnetic reed switch” and “disc magnet/magnetic reed switch”. Both of these terms mean the same thing and that is a device including a magnetic disc and a magnetic reed switch or the like associated in a manner such that the magnetic disc can move into and/or out of the magnetic field of the magnetic reed switch or the like

By this reference I incorporate the claims and abstract, which follow, within, and as a part of, this description of a preferred embodiment the same as though they were fully set forth again at this position.

In the event I should fail to claim any properly patentable feature of this invention, such failure to claim will be due to inadvertence and is not to be an indication of any abandonment or dedication of such feature.

While the embodiments of this invention which have been shown and described are fully capable of achieving the objects and advantages desired, such have been shown and described for purposes of illustration only and not for purposes of limitation.

1. A method for electrical switching comprising: placing a magnetic reed switch having at least two electrical contacts adjacent support means for a disc magnet in such manner that a portion of the support means will be within and a portion of the support means will be without the magnetic field of the reed switch; placing a disc magnet on the support means at a location without the magnetic field of the magnetic reed switch; and causing the disc magnet to move to a position within the magnetic field of the magnetic reed switch thus activating the magnetic reed switch.

2. The method of claim 1 wherein the disc magnet is caused to move by a stream of fluid being directed against the disc magnet.

3. The method of claim 1 wherein the disc magnet is caused to move by force of gravity.

4. The method of claim 1 wherein the support includes at least one plane surface which is angularly inclined with respect to horizontal.

5. The method of claim 1 wherein the disc magnet is caused to move by an impact against the support means.

6. An electrical switching device comprising: a magnetic reed switch; magnetic reed switch holding means; a disc magnet supported by disc magnet support means; and means to move the disc magnet into and out of the magnetic field of the reed switch.

7. The device of claim 6 wherein the means to move the disc magnet includes a surface which is inclined with respect to horizontal.

8. The device of claim 6 wherein the means to move the disc magnet includes gravitational forces.

9. The device of claim 6 wherein the means to move the disc magnet includes impact means.

10. A method for a disabled person to communicate which includes: causing a disc magnet upon a disc magnet support surface to roll from a position exterior the magnetic field of a magnetic reed switch associated with the disc magnet support surface to a position interior said magnetic field.

11. An electrical switching apparatus comprising: a magnetic reed switch; magnetic reed switch holding means; a disc magnet supported by disc magnet support means; a magnetic disc magnetic restraining means normally restraining the magnetic disc from entering the magnetic field of the magnetic reed switch; and means to overcome the magnetic restraining means so as to allow movement of the disc magnet into and out of the magnetic field of the reed switch.

12. The apparatus of claim 11 where the restraining means includes magnetic means.

13. The apparatus of claim 11 where the restraining means includes mechanical means.

14. The apparatus of claim 11 where the restraining means includes electrical means.

15. Apparatus for disabled, handicapped, invalid, and other persons and the like to control a variety of devices comprising: a plurality of magnetic disc/magnetic reed switch wireless transmitter devices each of which is on a specific wireless frequency different from each of the others and each of which is accessible to, and capable of being activated by a person; a plurality of wireless receiver devices each of which is on a specific wireless frequency which matches the frequency of one of the transmitter devices and is connected to a device which may be activated by receipt of a signal by the receiver device from the frequency matching transmitter device.

16. The apparatus of claim 15 wherein each of the magnetic disc/magnetic reed switch wireless transmitter devices is capable of being activated by the breath of a person directed against a magnetic disc.
